(19) United States
(12) Patent Application Publication
(10) Pub. No.: US 2006/0036595 A1
(43) Pub. Date: Feb. 16, 2006

(54) Role-based dynamically customizable dashboards

(75) Inventors: Michael Gilfix, Austin, TX (US); David Perry Greene, Austin, TX (US); Vani Prasad, Austin, TX (US); Daniel R. Roth, Somerville, MA (US); William R. Salinas, Pittsburgh, PA (US); William Streit, Cedar Park, TX (US)

Correspondence Address: IBM CORPORATION (CS);C/O CARR LLP, 670 FOUNDERS SQUARE, 900 JACKSON STREET, DALLAS, TX, 75202, US

(73) Assignee: International Business Machines Corporation, Armonk, NY (US)

(21) Appl. No.: 10/916,978

(22) Filed: Aug. 12, 2004

(51) Int. Cl. G06F 17/30

(52) U.S. Cl. 707/5

(57) ABSTRACT

The present invention provides for sharing information among a plurality of dashboards. Employment of at least one metric of a first dashboard is monitored. An indicia of the monitored metric is transmitted. The indicia of the monitored metric is received. An indicia associated with the monitored metric is displayed on a second dashboard, thereby enabling a user of the second dashboard to know what metrics a user of the first dashboard are employing.

### TECHNICAL FIELD

The invention relates generally to business dashboards and, more particularly, to the sharing of information among business dashboards.

### BACKGROUND

There are a variety of metrics that can be used to measure productivity in the workplace. One of these measurements is known as a dashboard. Specifically, a dashboard can be generally defined as a high level visual representation of data, that uses bars and graphs to show various factors of merit, such as in a business context. The dashboard is designed to provide executives or other interested parties with a compressed, high level view of a business performance through providing the representation of key performance indicators distilled from large collections of data. In more general terms, a dashboard can be generally regarded as a “window” into the business status.

However, there are problems associated with conventional dashboards. One problem is that the end user is unaware of what other people in the business hierarchy are using as metrics. These can be people above the end user, below the end user, or at the same hierarchical level as the end-user.

In conventional dashboards, the templates for the metrics to be used by an individual user are set statically. In other words, employees are given a set of metrics from which to choose and construct their display. These metrics can be updated by the end user, but changes to the display are limited to those changes explicitly made by the user. If a new metric is added to the system, the system administrator has to alert individuals that a change has been made.

There are other problems with the traditional dashboard. These users have to be told that new updates are available. Furthermore, users may not realize that a particular metric is crucial to their job. As IT infrastructures evolve, and the business requirements of those infrastructures evolve, so will the window into the business. Workers within IT will typically be responsible for creating new content for the window, and making it available to the public or within the business entity. However, dissemination of that new function can be difficult.

Therefore, there is a need for a dashboard that addresses at least some of the concerns associated with conventional dashboards.

### SUMMARY OF THE INVENTION

The present invention provides for sharing information among a plurality of dashboards. Employment of at least one metric of a first dashboard is monitored. An indicia of the monitored metric is transmitted. The indicia of the monitored metric is received. An indicia associated with the monitored metric is displayed on a second dashboard. In one aspect, the displays are configured to show the relative frequency of usage of the metrics. In a further aspect, the data associated with the metric is shown.

### BRIEF DESCRIPTION OF THE DRAWINGS

For a more complete understanding of the present invention, and the advantages thereof, reference is now made to the following Detailed Description taken in conjunction with the accompanying drawings, in which:

FIG. 1 disclosed a system in which measurements employed within a plurality of dashboards can be shared. schematically depicts;

FIG. 2 illustrates exemplary hierarchies of information that can be used in conjunction with FIG. 1; and

FIG. 3 illustrates illustrated is one example of use of the system for sharing dashboard information through the employment four separate metric windows.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, and the like, have been omitted inasmuch as such details are not considered necessary to obtain a complete understanding of the present invention, and are considered to be within the understanding of persons of ordinary skill in the relevant art.

In the remainder of this description, a processing unit (PU) may be a sole processor of computations in a device. In such a situation, the PU is typically referred to as an MPU (main processing unit). The processing unit may also be one of many processing units that share the computational load according to some methodology or algorithm developed for a given computational device. For the remainder of this description, all references to processors shall use the term MPU whether the MPU is the sole computational element in the device or whether the MPU is sharing the computational element with other MPUs, unless otherwise indicated.

It is further noted that, unless indicated otherwise, all functions described herein may be performed in either hardware or software, or some combination thereof. In a preferred embodiment, however, the functions are performed by a processor, such as a computer or an electronic data processor, in accordance with code, such as computer program code, software, and/or integrated circuits that are coded to perform such functions, unless indicated otherwise.

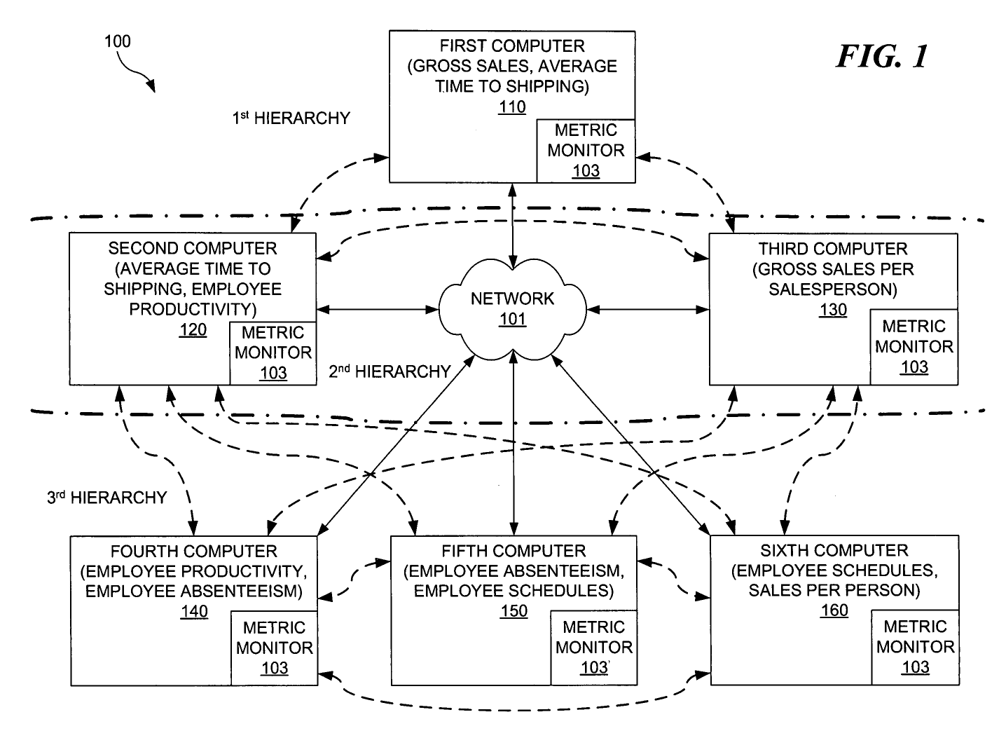

Turning to FIG. 1, disclosed is a system 100 in which measurements employed within a plurality of dashboards can be shared. A first computer 100 is coupled through to a network. A second computer 120, a third computer 130, a fourth computer 140, a fifth computer 150, and a sixth computer 160 are also coupled to the network.

Generally, the system 100 is directed to the presentation of metrics or other measurements of interest of those in levels higher lower and the same level of a business hierarchy, thereby allowing for the propagation of a metric throughout a hierarchical system. The system 100 shows one end user what metrics other end users above him in the hierarchy are using, below him in the hierarchy are using, and on the same level of the hierarchy are using, along with the frequency of use of each metric. Furthermore, if the metric itself is visible to the computer, then the data upon which the metric is based will also be visible to the computer. However, in some embodiments, members of the hierarchy will be restricted from accessing some metrics of other members of the hierarchy, and this restriction can also include frequency of accessing the metrics and the underlying data upon which the metric is based itself. For instance, those lower in a hierarchy can be forbidden from accessing data that is accessible at a higher level in the hierarchy, such as data regarding employee performance.

In the system 100, each computer 110 to 160 has a metric monitor 103. The metric monitor 103 reports to the network 101 the metrics that are being viewed by its corresponding computer. These metrics reports are then processed and transferred by the network 101 to the other computers, as appropriate to the higher, lower, or same levels of the hierarchy.

The system 100 can use a hierarchical organizational chart, such as the Blue Pages of IBM®, to determine who is where in a hierarchy. The system 100 can then determine who is relevant to a particular individual in the hierarchy. Relevancy can be defined as those who are in specified places above, below, and lateral to an individual in a hierarchy. An algorithm for use with the outputs of the various metric monitors 103, can then be used to display to a given user what metrics typical members of a given layer of hierarchy are using. Alternatively, all the metrics the members of a hierarchy are using is given to the end user.

For instance, in the system 100, the first computer corresponds to the highest level of a business hierarchy, for instance, the President's computer or the head of a department. In FIG. 1, the President has two metrics that he or she monitors. These are the gross sales of the company for a given time period, and the average time to shipping of a given business unit. Furthermore, the metrics can include frequency of use metrics by those lower in the hierarchy, as well as the information itself.

In the system 100, the fact that the first hierarchy (that is, the President of the company) is tracking this information is visible to the second computer 120 and the 130 of the second level of the hierarchy. This information can be used by the user of each computer 120, 130 to determine what information and metrics he or she wishes to display on his or her own computer 120, 130. For instance, the second computer 120 is displaying the average time to shipping metric, which the second computer 120 displays as also displayed on the first computer 110 of the first hierarchy. However, the second computer 120 also displays an “employee productivity” metric. The user of the second computer 120 can also see what the third computer 130 is viewing for metrics, and what the fourth, fifth, and sixth computers 140, 150 and 160, are viewing. The computers 140, 150 and 160 are lower in the hierarchy than the computer 120, but are visible to the computer 120.

The user of the third computer 130, however, after viewing the metrics used by the first computer 110, and the second computer 120 selects “gross sales” and “sales per salesperson”. However, the third computer 130 can read the type of metrics generated by the first, second, fourth, fifth and sixth computers 110, 120, 140, 150, and 160. In a similar manner, the fourth computers 140 through 160 can view the metrics viewed by other members of the appropriate levels of the business hierarchy.

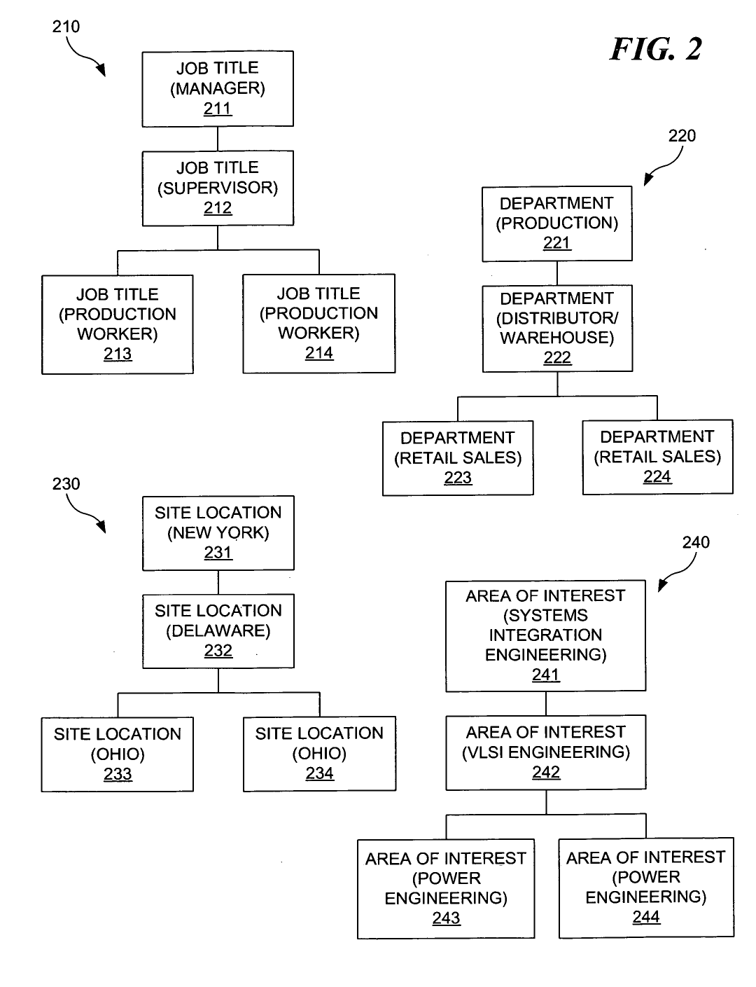

Turning now to FIG. 2, illustrated are exemplary hierarchies of information that can be used in conjunction with the system 100.

A first exemplary hierarchy 210 concerns the sharing of dashboard information for those of differing job titles. A manager 211 can view information of a supervisor 212, and the supervisor 212 can view dashboard information of the manager. Likewise, production workers 213, 214, can view dashboard information of the supervisor 212.

A second exemplary hierarchy 220 concerns the sharing of dashboard information for those of differing departments. A production department 221 can view information of a distribution department 222, and the distribution department 222 can view dashboard information of the production department 221. Likewise, retail sales departments 223, 224, can view dashboard information of the distribution department 222.

A third exemplary hierarchy 230 concerns the sharing of dashboard information for those of differing site locations. A New York site 231 can view information of a Delaware site 232, and the Delaware site 232 can view dashboard information of the New York site 231. Likewise, the Ohio Sites 233, 234, can view dashboard information of the Delaware site 222.

A fourth exemplary hierarchy 240 concerns the sharing of dashboard information for those of differing interests. A systems integration engineer 241 can view information of a VLSI engineer 242, and the VLSI 242 can view dashboard information of the systems engineer 241. Likewise, the power supply engineers 243, 244, can view dashboard information of the VLSI engineer 242.

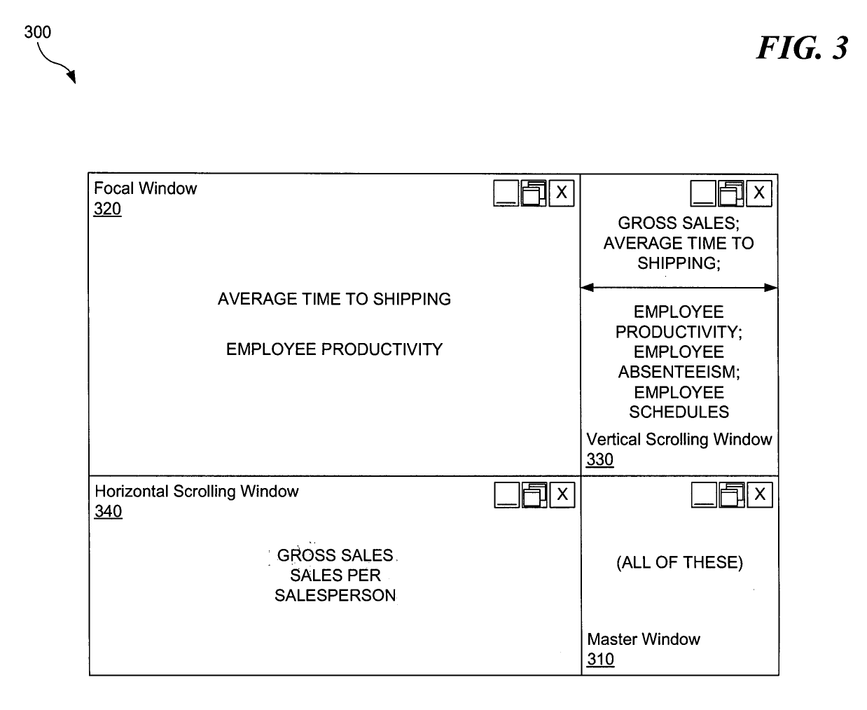

Turning now to FIG. 3, illustrated is one example of use of the system for sharing dashboard information through the employment four separate metric windows 310, 320, 330, 340. Each of these windows 310, 320, 330, 340 show the metrics that the other relevant members of the business hierarchy are viewing, such as, for example, hierarchy 310, 320, 330, and 340. For ease of illustration, a system 300 is illustrated as could be seen by a user of the second computer 120. However, those of skill in the art understand that the illustrations of the system 300 could also be applied to other computers. When viewing the metrics that have been used by other viewers, the underlying data itself can be viewed by the various computers. Also, the frequency of use can be shown in regards to each metric. The frequency of use could be illustrated as color coded, such as red for the most frequently accessed, yellow for somewhat frequently accessed, and green for the least frequently accessed. Alternatively, indicia indicating percentage of access by the other computers as a metric could also be used, such as a percentage sign with the appropriate number.

The first window is a master window 310. The master window 310 displays all of the possible metrics available to a user as a function of his role in the organization. In other words, the master window 310 shows all the metrics that could be accessed by the second computer 120.

The second window, the focal window 320, displays the metrics that are presently deemed “important” to the user, as these are the metrics being actively being used by the viewer. When the individual first joins the organization, the metrics on display within this window can display the maximum array of metrics used by other individuals at the same level of the hierarchy are using, the lowest common denominator of the metrics that individuals at the same level of the organization are being used, or any combination of the two. However, these metrics can be adjusted. These metrics are adjusted either by that individual individually discovering a new metric in the main window 310, or being informed of the use of a new metric by those in either the same or other members of the hierarchy through the use of the dashboard 300, as will be explained below. In the illustrated embodiment of the dashboard 300, the metrics of import are shown to be “Average Time to Shipping” and “Employee Productivity”. These adjustments can be made by “dragging and dropping” icons from the horizontal 240, vertical 230 or master 210 scrolling window.

Window 330 is the vertical scrolling window. The vertical scrolling window 330 discloses what those above that individual, both higher and lower in the hierarchy, are viewing as metrics. This can show the greatest range of metrics used by others both higher and lower in the hierarchy, the most commonly used metrics by others higher and lower in the hierarchy, the most commonly accessed metrics used by others, and so on.

Finally, in the horizontal scrolling window, the metrics that are used by other end users at a similar level of the hierarchy are displayed to the end user.

The end result of all of this disclosure is that changes in metrics and new popular metrics can populate through the system quickly, without changes being mandated by administration. For example, suppose that someone at a given level of the hierarchy (level “2”), discovers that a certain metric is very appropriate for the attributes of the business with which he is concerned. He will then copy that metric from the main window 310 to the focal window 320.

However, this change will be noticed by others within the hierarchy. At level “1” (assuming that level 1 is the apex of this system), the chief supervisor will notice on her vertical scrolling window 330 that a subordinate in layer “2” is using this particular metric. The end user at level “1” may or may not decide to use that metric, but in any event, it is useful to know what measurements that one's subordinates regard as a good measure of progress of the business. Co-workers at the same level (level “2”) will again know what the one co-worker is using, and can decide to incorporate this metric into their own personalized focal window 320. Finally, subordinates will know what their immediate supervisor (or, for that matter, what the group aggregate of supervisors) regard as important, and if so, can add some of these measurements to the metrics that they view in each individual focal window 320. However, in a further embodiment, those supervised will be denied access to specified metrics of those above them in the hierarchy. In other words, both the fact of the use of the metric, and the underlying data itself, will be denied the level supervised.

In a further embodiment, the various non-forbidden metrics used by the other computers of the hierarchy scroll across the bottom of the window 240. This could be used, for instance, in circumstances in which the various metrics of use change frequently by the various members of the hierarchy. These metrics can be periodically updated.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A method for sharing information among a plurality of dashboards, comprising:
monitoring employment of at least one metric of a first dashboard;
transmitting an indicia of the monitored metric;
receiving the indicia of the monitored metric; and
displaying an indicia of the monitored metric on a second dashboard.

2. The method of claim 1, further comprising selecting the displayed indicia on the second dashboard.

3. The method of claim 2, further comprising displaying information correlating to the selected displayed indicia on the second dashboard.

4. The method of claim 2, further comprising deselecting the displayed indicia on the second dashboard.

5. The method of claim 1, further comprising organizing the first dashboard and the second dashboard into a hierarchy.

6. The method of claim 5, further comprising placing the first dashboard at a different level of the hierarchy than the second dashboard.

7. The method of claim 5, further comprising placing the first dashboard at the same level of the hierarchy than the second dashboard.

8. The method of claim 5, further comprising displaying the monitored metric as a function of the first dashboards position in the hierarchy.

9. The method of claim 5, wherein the monitoring is performed on at least one other dashboard at the same level of the hierarchy.

10. The method of claim 1, further comprising accessing the data associated with the at least one metric.

11. The method of claim 1, further comprising generating indicia of use of the at least one metric, and displaying the indicia of use with the at least one metric.

12. The method of claim 1, further comprising updating the at least one metric at a substantially periodic interval.

13. A system for sharing metrics between dashboards, comprising:
a first computer;
a second computer coupled to the first computer, wherein at least the first computer further comprises an associated metric monitor; and
wherein at least the second computer is configured to display a display indicia associated with a indicia generated by the metric monitor.

14. The system of claim 13, wherein the first and second computer are associated through a hierarchy.

15. The system of claim 13, wherein the second computer is further configured to display data associated with the indicia generated by the metric monitor.

16. A computer program product for sharing information among a plurality of dashboards, the computer program product having a medium with a computer program embodied thereon, the computer program comprising:
computer code for monitoring employment of at least one metric of a first dashboard;
computer code for transmitting an indicia of the monitored metric;
computer code for receiving the indicia of the monitored metric; and
computer code for displaying an indicia of the monitored metric on a second dashboard.

17. A processor for sharing information among a plurality of dashboards, the processor including a computer program comprising:
computer code for monitoring employment of at least one metric of a first dashboard;
computer code for transmitting an indicia of the monitored metric;
computer code for receiving the indicia of the monitored metric; and
computer code for displaying an indicia of the monitored metric on a second dashboard.

18. The processor of claim 17, further comprising computer code for selecting the displayed indicia on the second dashboard.

19. The processor of claim 18, further comprising computer code for displaying information correlating to the selected displayed indicia on the second dashboard.

20. The processor of claim 18, further comprising computer code for deselecting the displayed indicia on the second dashboard.
